(19) United States
(12) Patent Application Publication
(10) Pub. No.: US 2012/0142204 A1
(43) Pub. Date: Jun. 7, 2012

(54) ELECTRICAL WALL OUTLET

(76) Inventors: HOLLY EBERHARD, Battle Creek, MI (US); Steve Eberhard, Battle Creek, MI (US)

(21) Appl. No.: 12/957,540

(22) Filed: Dec. 1, 2010

(51) Int. Cl. H01R 13/70

(52) U.S. Cl. 439/188

(57) ABSTRACT

The present invention relates to a wall outlet for controlling electrical current to said outlet comprising: at least one socket, where electrical power is supplied to the at least one socket; and an on/off switch wired in series with the at least one socket, where said on/off switch enables the user to cut electrical power the at least socket. In one exemplary embodiment, each socket includes two electrical contacts, where one contact is a live wire and other contact is a neutral wire. In yet another exemplary embodiment, each socket includes three electrical contacts, where one contact is a live wire, a second contact is a neutral wire and a third contact is a ground wire.

### BACKGROUND OF THE INVENTION

1. Field of Invention

The present invention relates to a unique electrical outlet that incorporates an on and off switch.

2. Description of Related Art

Electricity is supplied to buildings and homes through a series of electrical circuits. The electrical circuits lead throughout the building and electricity is supplied usually through the use of wall outlets. Wall outlets or sockets include female electrical connectors that have slots or holes, which are adapted to deliver current to the prongs of inserted plugs. Some sockets include a pair of connectors that form the socket; others include three connectors capable of grounding the electrical connection where a livewire, a neutral wire and a ground wire are provided for such a socket. The sockets are usually in pairs where one socket is positioned above another in one column. Although other sockets have been known such as a quad socket or socket light switch combination however, the conventional socket usually includes a paired configuration.

The wall sockets are connected to a main circuit breaker and are fed electricity through the circuit breaker continuously once power is supplied to the building or home. The wall outlet is therefore active once it is connected to the circuit breaker and available to supply electricity upon the insertion of a plug.

Due to modern concerns with energy consumption, it would be advantageous to be able to control the electricity supplied at a wall outlet in order to reduce or eliminate the energy dissipated when either the electrical device that is plugged into the wall outlet is not in use or if the wall outlet itself is not in use. As stated above, a wall outlet is typically connected to a circuit breaker, which supplies a continuous flow of electricity that is available to the wall outlet. The continuous flow of electricity therefore creates a certain loss of energy that could be saved over a period of time.

It would therefore be advantageous to provide further control of the electrical supply to the wall outlet in order to reduce the consumption of power during times of non-use.

### SUMMARY OF THE INVENTION

The present invention relates to a wall outlet for controlling electrical current to said outlet comprising: at least one socket, where electrical power is supplied to the at least one socket; and an on/off switch wired in series with the at least one socket, where said on/off switch enables the user to cut electrical power the at least socket. In one exemplary embodiment, each socket includes two electrical contacts, where one contact is a live wire and other contact is a neutral wire. In yet another exemplary embodiment, each socket includes three electrical contacts, where one contact is a live wire, a second contact is a neutral wire and a third contact is a ground wire.

### BRIEF DESCRIPTION OF DRAWINGS

FIG. 1 depicts an exemplary embodiment of the wall outlet according to the present invention.

### DETAILED DESCRIPTION

The present invention relates to a wall outlet capable of controlling electrical supply directly to the outlet via the use of an on/off switch. The present invention incorporates a switch, which is able to cut electrical supply to the wall outlet and therefore reduce energy loss that may be associated with an idle wall outlet. The wall outlet according to the present invention may replace existing wall outlets or be utilized in the new construction as a device that may be used to conserve energy and therefore reduce overall energy consumption.

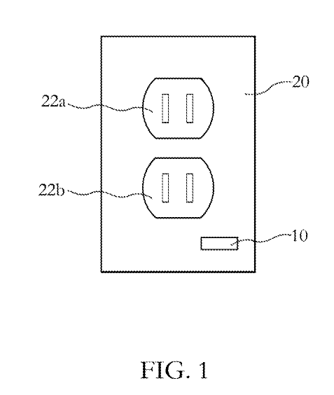

FIG. 1 depicts a wall outlet 20 according to the present invention. The wall outlet 20 includes two sockets 22a, 22b that are aligned in one vertical column. Just below the outlets 22a, 22b is a switch 10, which enables a user to switch the outlet 20 on or off as desired.

The general objective of the wall outlet 20 according to the present invention is to optimize energy consumption and therefore provide the consumer with the control to cut electricity to individual wall outlets throughout a wall or building. The switch 10 may be switched to an off position either when the outlet is not in use, or where appliances or electrical devices are connected to the outlet, when these appliances or electrical devices are not being used. The manual switch 10 is particularly advantageous when devices are plugged into the wall outlet 20 according to the present invention. The switch 10 is integrated with the wall outlet 20, however in an alternative embodiment the switch 10 may be a separated from the wall outlet 20 and used as a separate wall switch. When used as a separate wall switch, the switch functions to cut the transmission of electrical current to the wall outlet 20. Many electrical devices continue to draw electrical current although in small amounts while the device is not in use by the consumer. The ability to switch the wall outlet to an off position therefore cuts this consumption and reduces power consumption over a period of time.

The switch 10 may function as a means to cut transmission of current to the wall outlet 20. The switch 10 may be mechanically actuated between an on or off position or alternatively a sensor may be provided such as a motion sensor or touch sensor may be implemented to toggle the switch from between the on and off positions. When such a motion sensor is adopted for implementation with switch 10, then upon detecting motion in the room where the outlet 20 is located the current transmission to the outlet 20 is executed. Where a touch sensor is adopted for implementation with switch 10, then a user merely touches the sensor to activate current transmission to the outlet 20.

The switch 10 therefore eliminates the necessity for an individual to actually unplug appliances to cut consumption and they may be left within the wall outlet when not being utilized. Although the wall outlet 20 is depicted as a two-contact socket, the present invention is also capable of being implemented on a wall outlet with a ground connection. The present invention may therefore be expanded for use in a three-contact wall socket as known in the prior art. In addition to the three-prong socket, the wall outlet according to the present invention may be implemented in other wall outlet systems known throughout the world. Consequently, the present invention which combines the on/off switch with a standard size outlet may be applicable on various types of wall outlets known in the prior art.

What is claimed is:

1. A wall outlet for controlling electrical current to said outlet comprising:
a. at least one socket, where electrical power is supplied to the at least one socket; and
b. an on/off switch wired in series with the at least one socket, where said on/off switch enables the user to cut electrical power the at least socket.

2. The wall outlet according to claim 1, where each socket includes two electrical contacts.

3. The wall outlet according to claim 2, where one contact is a live wire and other contact is a neutral wire.

4. The wall outlet according to claim 1, where each socket include three electrical contacts.

5. The wall outlet according to claim 4, where one contact is a live wire, a second contact is a neutral wire and a third contact is a ground wire.

6. The wall outlet according to claim 1, where the on/off switch is implemented through the use of at least one of a motion sensor and a touch sensor.

7. A wall outlet for controlling electrical current to said outlet comprising:
a. two sockets, where electrical power is supplied to the two sockets; and
b. an on/off switch wired in series with the two sockets, where said on/off switch enables the user to cut electrical power the two sockets.

8. The wall outlet according to claim 7, where each socket includes two electrical contacts.

9. The wall outlet according to claim 8, where one contact is a live wire and other contact is a neutral wire.

10. The wall outlet according to claim 7, where each socket include three electrical contacts.

11. The wall outlet according to claim 10, where one contact is a live wire, a second contact is a neutral wire and a third contact is a ground wire.

12. The wall outlet according to claim 7, where the on/off switch is implemented through the use of at least one of a motion sensor and a touch sensor.
